(19) United States
(12) Patent Application Publication
(10) Pub. No.: US 2014/0279698 A1
(43) Pub. Date: Sep. 18, 2014

(54) SYSTEMS AND METHODS FOR MULTIVARIATE SORTING OF FINANCIAL DATA

(71) Applicant: Trade Ideas, LLC, Carlsbad, CA (US)

(72) Inventors: Daniel Mirkin, Carlsbad, CA (US); Philip Smolen, Carlsbad, CA (US)

(73) Assignee: Trade Ideas, LLC, Carlsbad, CA (US)

(21) Appl. No.: 14/214,773

(22) Filed: Mar. 15, 2014

Related U.S. Application Data
(60) Provisional application No. 61/792,134, filed on Mar. 15, 2013.

(51) Int. Cl. G06Q 40/06

(52) U.S. Cl. CPC G06Q 40/06; G06Q 40/04
USPC 705/36 R

(57) ABSTRACT

Systems, methods and computer program products providing a multivariate sorting solution for presenting financial instrument data using multiple concurrent sorting methods including server-side, client-side, and color assist. The multivariate sorting solution for financial data generally includes a datacenter receiving financial market data. A datacenter server of the datacenter may use mathematical algorithms to analyze, sort, and prioritize the market data. The datacenter server may then make the analyzed, sorted, and prioritized data available for the client-side financial data application running on the end users computer. The data may be dynamically sorted again on the client application's display on the end users computer, and an additional color sorting scheme may be applied to the data list displayed on the end user's computer for improved visualization of the data.

### CROSS-REFERENCE TO RELATED APPLICATIONS

This application claims priority to, and the benefit under 35 U.S.C. §119(e), of U.S. Provisional Patent Application No. 61/792,134, filed 15 Mar. 2013, the entire contents and substance of which are hereby incorporated by reference as if fully set forth below.

### BACKGROUND

Conventional software tools can present large amounts of financial market data for presentation to end users in a human digestible format. However, conventional techniques for presenting financial data quote lists typically allow sorting across only a single field or variable. Accordingly, visualizing trends and outliers across a second variable can be difficult when viewing a list sorted by a first variable, even when such data points would stand out when presented in an alternate arrangement based on the second variable.

### SUMMARY

Certain embodiments of the present invention include systems and methods for multi-level filtering and multivariate sorting of financial instrument data. In an example embodiment, server-side filtering of financial data received at datacenter may be applied ahead of dynamic client-side filtering at a downstream client application. In another example embodiment, a color-sorting scheme for second criteria may be applied to a data list also spatially sorted according to first criteria. Such systems, methods, and computer-program products may provide improved visualization of data for revealing trends, outliers, and other data points of interest.

According to an example embodiment, a method is provided. The method may include receiving market data related to a first plurality of financial instruments. The market data may include sortable data for a first aspect and a second aspect associated with the first plurality of financial instruments. The method may further include outputting a visual representation of the market data. The visual representation may comprise a table having a plurality of rows corresponding to the first plurality of financial instruments, and a plurality of columns including a first column corresponding to the first aspect and a second column corresponding to the second aspect.

The method may yet further include, responsive to receiving an indication to sort by the first aspect, sorting in a first instance, according to the first aspect, the market data related to the subset of the plurality of financial instruments. The relative position, in the table, of rows corresponding to the first plurality of financial instruments may be selected to reflect the sorting in the first instance. The method may also include, responsive to receiving an indication to sort by the second aspect, sorting in a second instance, according to the second aspect, the market data related to the subset of the plurality of financial instruments. The plurality of colors associated with rows in the table corresponding to the first plurality of financial instruments may be selected to reflect the sorting in the second instance. The sorting in the first instance and the second instance may be concurrently reflected in the table.

According to another example embodiment, a method is provided. The method may include receiving market data related to a subset of a plurality of financial instruments. The market data may include sortable data for a first aspect and a second aspect associated with the plurality of financial instruments. The subset of the plurality of financial instruments may be selected from the plurality of financial instruments based on a threshold corresponding to a third aspect associated with the plurality of financial instruments. The market data may be received at a client system or device, from a server system or device. The subset may be selected at the server or system or device.

The method may further include outputting a visual representation of the market data. The visual representation may comprise a table having a plurality of rows corresponding to the subset of the plurality of financial instruments, and a plurality of columns including a first column corresponding to the first aspect and a second column corresponding to the second aspect. The visual representation may be output for display at the client system or device.

The method may yet further include, responsive to receiving an indication to sort by the first aspect, sorting in a first instance, according to the first aspect, the market data related to the subset of the plurality of financial instruments. A relative position, in the table, of rows corresponding to the subset of the plurality of financial instruments may be selected to reflect the sorting in the first instance. The method may also include, responsive to receiving an indication to sort by the second aspect, sorting in a second instance, according to the second aspect, the market data related to the subset of the plurality of financial instruments. A plurality of colors associated with rows corresponding to the subset of the plurality of financial instruments may be selected to reflect the sorting in the second instance. The plurality of colors may be based on a gradient between two colors, for example, a first color from the two colors corresponding to a first value for the second aspect and a second color from the two colors corresponding to a second value for the second aspect. The sorting in the first instance and the second instance may be concurrently reflected in the table.

Other embodiments, features, and aspects of the present invention are described in detail herein and are considered a part of the claimed present invention. Other embodiments, features, and aspects may be understood with reference to the following detailed description, accompanying drawings, and claims.

### BRIEF DESCRIPTION OF THE FIGURES

The patent or application file contains at least one drawing executed in color. Copies of this patent or patent application publication with color drawing(s) will be provided by the Office upon request and payment of the necessary fee. Reference will now be made to the accompanying figures and flow diagrams, which are not necessarily drawn to scale, and wherein:

FIG. 1 depicts a flowchart 100 illustrating a flow of market data 101 from the financial markets to the multivariate list display 105, according to an example embodiment.

FIG. 2 depicts a flowchart 200 illustrating an overview of sorting operations, as related to the datacenter server 305, client application 205, and multivariate display 105, according to an example embodiment.

FIG. 3 depicts a flowchart 300 illustrating operations for configuring the multivariate display 105, as related to the datacenter server 205 and client application 205, according to an example embodiment.

FIG. 4 depicts a multivariate list window 400 displaying data sorted by first criteria 405, according to an example embodiment.

FIG. 5 depicts two multivariate list windows 500A 500B displaying the same data sorted by a first and second criteria 505A 505B, respectively, according to an example embodiment.

FIG. 6 depicts a multivariate list window 600A with a color assist configuration window 600B set to display fixed colors 615, according to an example embodiment.

FIG. 7 depicts a multivariate list window 700A with a color assist configuration window 700B set to display fixed colors 715, according to an example embodiment.

FIG. 8 depicts a multivariate list window 800A with a color assist configuration window 800B set to display a gradient of colors 815, according to an example embodiment.

FIG. 9 depicts a multivariate list window 900A displaying data spatially sorted by a first criteria 905A with a color assist configuration window 900B set to display a combination of fixed and gradient colors, according to an example embodiment.

FIG. 10 depicts the same multivariate list window as FIG. 9, the data now spatially sorted by a second criteria 905B, with the color assist configuration window 900B, according to an example embodiment.

FIG. 11 depicts two multivariate list windows 1100A 1100B displaying the same data spatially sorted by different criteria 1105A 1105B, respectively, the right multivariate list window 1100B having a color assist gradient according to criteria 1105B, according to an example embodiment.

FIG. 12 depicts two multivariate list windows 1200A 1200B displaying the same data spatially sorted by different criteria 1205A 1205B, respectively, but having color assist gradients according to the same criteria 1205A, according to an example embodiment.

FIG. 13 depicts two multivariate list windows 1300A 1300B displaying the same data spatially sorted by a same first criteria 1305A, the right multivariate 1300B list window having a color assist gradient on a second criteria 1305B, according to an example embodiment.

FIG. 14 depicts a multivariate list window 1400A and a top-list configuration settings dialog window 1400B, according to an example embodiment.

FIG. 15 depicts a flow chart of a method 1500, according to an example embodiment.

FIG. 16 depicts a flow chart of a method 1600, according to an example embodiment.

FIG. 17 depicts a block diagram 1700 of illustrative computer system architecture according to an example embodiment.

### DETAILED DESCRIPTION

Certain embodiments of the present invention include systems, methods, and computer-program products for multi-level filtering and multivariate sorting of financial instrument data, herein referred to as part of the “TI-Pro” system. In an example embodiment, data satisfying initial filter or sort criteria may be compiled on a server and delivered to a client device. If a color scheme has been assigned, it may be applied to the display of the data at the client device, resulting in a color sort of second independent criteria. In another embodiment, a third sorting option may be available that may spatially sort any column of the available data, for example, in ascending or descending order. The result is a dynamic window that may generate a top list of data server-side filtered or sorted according to a first variable, colored on a second variable, and client-side sorted on a third variable.

To facilitate an understanding of the principles and features of embodiments of the present invention, various example embodiments are explained below. Although some example embodiments of the present invention are explained in detail, other embodiments are contemplated. Further, in describing the example embodiments, specific terminology will be resorted to for the sake of clarity. It is not intended that the present invention be limited in scope to the details of construction and arrangement of components set forth in the following description or illustrated in the drawings. Rather, the present invention is capable of other embodiments and of being practiced or carried out in various ways.

Throughout the specification and the claims, the following terms take at least the meanings explicitly associated herein, unless the context clearly dictates otherwise. The term “coupled” means that one function, feature, structure, or characteristic is directly or indirectly joined to or in communication with another function, feature, structure, or characteristic. Relational terms such as “first” and “second,” and the like may be used solely to distinguish one entity or action from another entity or action without necessarily requiring or implying any actual such relationship or order between such entities or actions. The term “or” is intended to mean an inclusive “or.” Further, the terms “a,” “an,” and “the” are intended to mean one or more unless specified otherwise or clear from the context to be directed to a singular form. The term “include” and its various forms are intended to mean including but not limited to.

### INTRODUCTION

Conventional techniques for presenting financial data such as quote lists typically allow sorting by only a single variable or a single combination of variables. Accordingly, visualizing trends and outliers across a second variable, or criteria, can be difficult when viewing a list sorted by a first variable, even when such data points would stand out in another arrangement of the data.

Certain embodiments of the present invention may improve the presentation of financial quote data by providing, for example, a unique display of market data through the concurrent application of server-side sorting and filtering, dynamic client-side sorting, and client configurable color settings. Although embodiments of this invention are described in the context of financial market data, one of skill in the art will understand the systems and methods disclosed to be generally applicable to the presentation of sortable data including textual, numerical, and graphical data.

Some embodiments of the present invention may be used to provide a multivariate sorting solution for organizing financial instrument data using multiple concurrent sorting methods. For example, some embodiments include providing one or more of server-side, client-side, and color-assisted sorting. Also, some embodiments may provide filtering of financial instrument data on the server side ahead of client-side sorting at a client application. Moreover, the client-side sorting may be dynamic, in addition to the initial server-side sorting or filtering.

Accordingly, certain embodiments of the present invention may facilitate the visual interpretation of displayed financial data. Various embodiments will now be described with reference to the accompanying figures.

### Market Data

FIG. 1 depicts a flowchart 100 illustrating a flow of market data 101 from the financial markets to the multivariate list display 105, according to an example embodiment. In an example embodiment, market data may include numerical price data, reported from trading venues, such as stock exchanges. The price data may be attached to a ticker symbol and additional data about the trade. Market data typically includes, but may not be limited to, the current trading volume and price for the equity, commodities, and options markets. Market data may also include relevant fundamental, proprietary, or derived data regarding the underlying companies, funds, or commodities. Derived data may be data that was originally supplied in one form, but was converted to another form using some automated process from existing data points. In some embodiments, the market data may be real-time or delayed financial instrument data.

### Datacenter Server

In an example embodiment, a datacenter may receive the market data via an Internet or direct connection. A datacenter server 305 of the datacenter may use mathematical algorithms to analyze, sort, filter, or prioritize the data. The datacenter server may then make the analyzed, sorted, filtered, or prioritized data available for a client-side financial data application 205 running, for example, on a client system or device.

A datacenter server 305 may be a single computing device or a set of computing devices having one or more of a market interface for receiving market data from various sources, a database for storing market data and retaining statistical baselines, statistical analysis units to identify patterns, and web services to publish data to an outside client interface.

### Client-side Software Application

In an example embodiment, a client-side financial data application 205 may be an online or installed software application accessed by an end user of a client system. The client-side application may receive market data from the datacenter server 305 or another source. The client-side application may then display the data received from the datacenter server according to a default or user-selected display configuration.

In one embodiment, a client-side application 205 may be a thin client that displays actionable trading ideas based upon a customized client configuration. Data may be processed in real-time on the datacenter server 305, filtered as appropriate, then transmitted to the client application interface for further manipulation. This manipulation may include, but is not limited to, defining client-side sorting and customized color configurations. In some embodiments, all or the majority of financial data processing may take place server-side with the thin client enabling the represented data to persist within a mobile application or a browser window.

### Server-side Sorting

FIG. 2 depicts a flowchart 200 illustrating an overview of sorting operations, as related to the datacenter server 305, client application 205, and multivariate display 105, according to an example embodiment. In some embodiments, the datacenter server 305 may conduct the first round of data sorting, filtering, or prioritizing prior to serving the data to the client resident software application or online software 304. The server-side organizing of market data may be configured and requested by default or user-selected settings according to the desired overall dataset for display.

Data may be transmitted from the datacenter server 305 in various configurations. In one embodiment, server-side sorting may take a universe of data and rank that data based on a selected aspect of the market data, such as stock price. The datacenter server may then transmit a predetermined number of symbols, e.g. the top fifty symbols, for client-side manipulation and analysis. In another embodiment, the datacenter server may transmit market data for all symbols meeting a threshold for an aspect of the market data.

In another embodiment, server-side sorting may continue to occur on the back-end as new data is generated by the market and automatically deliver new relevant issue to the client interface. For example, if a price associated with a stock changes, the price displayed at the client may be updated as well. In another example, if a status associated with a symbol previously un-included in the symbols transmitted to the client device changes to satisfy the limiting criteria at the datacenter server 305, the server may then include that symbol in the data transmitted to the client application 205. In some embodiments, when a predetermined number of symbols is specified, the inclusion of a new symbol in the transmitted data-stream may coincide with the removal of another symbol.

### Client-side Dynamic Sorting

In an example embodiment, the client application 205 may enable an end user to perform client-side dynamic sorting 303 of any aspect of the market data comprising sortable data. For example, in one embodiment, client-side dynamic sorting may further sort or organize a data list already sorted or filtered at the datacenter server 305 according to additional aspects or variables selected by the user.

In one embodiment, market data may be presented at a client device in a grid or table format, with rows representing financial instruments or symbols, and columns representing aspects of market data related to the financial instruments. Other configurations of rows and columns are possible and contemplated by the present disclosure. One or more aspects or variables may be a criteria suitable for sorting or filtering by. In an example embodiment, three column types are supported: numerical, textual, and graphical indicators. All three of these column types may be sortable. For example, text may be sorted alphabetically; numbers may be sorted numerically, and graphical indicators may be sorted by an associated numeric underlying value.

### Color-assisted Sorting

In an example embodiment, color-assisted sorting may be part of a default client view or configured by a user of the client application 205. In some embodiments, a set of colors may be defined for ranges of values within a display column to assist in visualization of the data while the data is spatially sorted by a differing column.

In one embodiment, a first step in defining a color scheme may be selecting which aspect or column will be used as the basis for the fixed color thresholds and/or color gradient. In some embodiments, color schemes may be defined in fixed colors or color gradients through a color selection widget (see e.g., 615). In one fixed-color configuration, a base value or range for an aspect and its associated color may be defined. Colors above the base value and below the base value may also be defined for a three-color option per defined value. In another embodiment, a color scheme may have virtually unlimited color value associations. For example, a color gradient may be defined by associating an initial color with a first value and another color with a second value. A color gradient spectrum may then extend between the two values, based on various fits or regressions.

### Multivariate Top-list Display

In an example embodiment, the multivariate top-list display 105 may be presented in a stand-alone application window at a client device, through a browser, or as a widget. The multivariate top-list display may comprise a Top-List Window. In an example embodiment, a Top-List Window may be a ranked list of securities that meet a filtering criteria associated with the window. In some embodiments, once all symbols that meet the criteria are assembled and sorted at the datacenter server 305, they may be presented at the top list window for additional sorting and manipulation. In some embodiments, the top list window may display historical data or real-time data. Moreover, in an example embodiment, a user may have the ability to “freeze” the data and continue working with the currently displayed or downloaded dataset as desired.

Operation of an Example Embodiment

FIG. 3 depicts a flowchart 300 illustrating operations for configuring the multivariate display 105, as related to the datacenter server 205 and client application 205, according to an example embodiment. In an example embodiment, to setup or configure the Top-List Window, the user may open a configuration dialog window (see e.g., 1400B). In this configuration window, filtering, prioritizing, server-side sorting, and data display columns may be selected. From the Top-List configuration window, the user may set any available limiting filters needed to restrict, or filter, the universe of financial instruments to the desired criteria. In some embodiments, types of filters may include, but are not limited to, settings that reflect trading volume, prices, ratios, types of market movements, fundamental data, and the exchange the security is listed on, or specific lists of securities.

In some embodiments, server-side sorting in the Top-List configuration window may be the first order of sorting for the Top-List Window. The user may select from one of many available types of data filters and set the priority for the “Biggest on Top” (highest value for the selected filter as the Top-List priority) or “Smallest on Top” (lowest value for the selected filter as the Top-List priority). The server may deliver a finite number of results based upon the desired configuration. The number of results may be based first on the applied filters and then on a max number of desired results value. In an example embodiment, the default value is 100 but may be limited to fewer or expanded to 1,000.

In some embodiments, when a user loads the configuration settings to the Top-List Window for displaying the multivariate sorting results for financial instruments, a list of financial instruments may be displayed from the filtered, sorted, and prioritized market data sent from the datacenter server 305. In an example embodiment, the window, by default, may display the server-side sorting chosen as the first priority for this Top-List Window. The user may then dynamically sort the window by any of the displayed data columns. In some embodiments, this dynamic sorting may be accomplished by double clicking on a column header. This may toggle the sort order between ascending, descending, and an original sort order of the data. Additionally, a color-assist color scheme may be applied to the strategy. The color scheme may be based on any one of the available column's ranges of values.

In an example embodiment, a multivariate color-assisted sort in the TI Pro system may reflect the following scenario: A user is interested in stocks between $10-$50 that are above the 200 days SMA and up at least 1% for the day. The server sort might be based on stocks up the most for the day. This will return the top 100 stocks up the most for the day in the price range specified that are above the 200 day SMA and up at least 1% for the day. The color gradient might be based on some fundamental data point like earnings per share (EPS). More specifically it might show stocks with higher EPS as darker than stocks with a lower EPS. Various columns may be visible in the grid display and available for a client-side sort. One such example might be position change in five days. Sorting on the change in five day column in descending order will provide a list of stocks down the most over five days but are up at least 1% today and above the 200 day SMA. The darker rows will stand out indicating which stocks have the highest EPS.

FIGS. 4-14 illustrate various windows and configurations of a client application interface of the TI-Pro system, according an example embodiment.

FIG. 4 depicts a multivariate list window 400 displaying data sorted by first criteria 405, according to an example embodiment. As shown in FIG. 4, the displayed data is sorted by percent of volume today on the server without any color specifications assigned.

FIG. 5 depicts two multivariate list windows 500A 500B displaying the same data sorted by a first and second criteria 505A 505B, respectively, according to an example embodiment. As shown in FIG. 5, the list on the left 500A is only sorted by percent volume today on the server and the client 505A. The list on the right 500B is first sorted by percent volume today on the server, and then sorted again by percent change since the open today 505B dynamically according to a user selection.

FIG. 6 depicts a multivariate list window 600A with a color assist configuration window 600B set to display fixed colors 615, according to an example embodiment. As shown in FIG. 6, the color assist configuration window is set to display the color gradient according to the “Up from the Close (%)” (see 610) data column. The configuration window is also set for numbers approaching five to become darker until they become black at five or above, and set to show numbers approaching negative five becoming lighter until they become white at negative five or lower (see 615).

FIG. 7 depicts a multivariate list window 700A with a color assist configuration window 700B set to display fixed colors 715, according to an example embodiment. As shown in FIG. 7, the color assist configuration window is currently set to display the fixed colors based on the “Change from the Close (%)” (see 710) data column. Any value greater than zero will be dark gray and any color below zero will be light gray, with zero values represented as white.

FIG. 8 depicts a multivariate list window 800A with a color assist configuration window 800B set to display a gradient of colors 815, according to an example embodiment. As shown in FIG. 8, the color assist configuration window is currently set to display a gradient of colors based on the “Change from the Close (%)” (see 810) data column. A value of zero in this data-set will result in a white color. As the value of “Change from the Close (%)” moves from 0 to 3, the color of the respective row will augment from light green (close to zero) to dark green (close to 3). At a value of 3 or higher, the row will be the defined green color. As the value moves from 0 to −3, the color spectrum will move from light red (close to zero) to dark red (close to −3). At a value of −3 or lower, the color will remain the defined fixed red color.

FIG. 9 depicts a multivariate list window 900A displaying data spatially sorted by a first criteria 905A with a color assist configuration window 900B set to display a combination of fixed and gradient colors, according to an example embodiment. As shown in FIG. 9, the color assist configuration window is currently set to display a combination of fixed and gradient colors (see 915) based on the “Change from the Close (%)” (see 910) data column. Any value equal to zero will be represented by a white background color. Between 0 and 2 will result in a gradient color from white to dark green, between 2 and 3 will result in a yellow gradient moving from light yellow to dark yellow. At a value of 3 or above, the color will remain at bright yellow. Conversely, a change from the close value between zero and negative 2 will result in a gradient spectrum from white to dark red. Between −2 and −3 will result in a gradient starting at pink and moving to purple at −3. Below −3 will remain a fixed color purple. FIG. 10 depicts the same multivariate list window as FIG. 9, the data now spatially sorted by a second criteria 905B, with the color assist configuration window 900B, according to an example embodiment. As shown in FIG. 10, the selected color settings combinations 915 remain the same.

FIG. 11 depicts two multivariate list windows 1100A 1100B displaying the same data spatially sorted by different criteria 1105A 1105B, respectively, the right multivariate list window 1100B having a color assist gradient according to criteria 1105B, according to an example embodiment. As shown in FIG. 11, the list on the left 1100A is only sorted by percent volume today on the server. The list on the right is first sorted by percent volume today on the server, and then sorted again by “Up from the Close (%)” dynamically according to a user selection. Additionally, the list on the right has the color assist gradient added to the “Up from the Close (%)” where the lighter numbers are higher numbers and the darker colors are lower numbers (including negative numbers).

FIG. 12 depicts two multivariate list windows 1200A 1200B displaying the same data spatially sorted by different criteria 1205A 1205B, respectively, but having color assist gradients according to the same criteria 1205A, according to an example embodiment. As shown in FIG. 12, both windows have the same color assist settings applied to the “Up from the Close (%)” (see 1205A) column. The lighter colors are more positive, the darker lower or more negative. In the left-hand window, both client and server sorts are set to “Up from the Close (%)”. In the right-hand window, the end user has changed the sorting order to “Up for the Year” (see 1205B) column.

FIG. 13 depicts two multivariate list windows 1300A 1300B displaying the same data spatially sorted by a same first criteria 1305A, the right multivariate 1300B list window having a color assist gradient on a second criteria 1305B, according to an example embodiment. As shown in FIG. 13, both windows have been sorted by the end user by the Up for the Year (%) (see 1305A) column. The left-hand window has no color assist settings. The window on the right has color assist settings applied to the “Up from the Close (%)” (see 1305B) column.

FIG. 14 depicts a multivariate list window 1400A and a top-list configuration settings dialog window 1400B, according to an example embodiment. As shown in FIG. 14, the configuration window is open to the Sort tab 1410. This window is showing that the server-side sorting is set to first sort all data for the window by “Volume Today (%)” 1415 with the biggest numbers on top 1420. The indication of the column sort in the multivariate list window may be seen at 1425.

Example Methods

FIG. 15 depicts a flow chart of a method 1500, according to an example embodiment. As shown in FIG. 15, the method 1500 starts in block 1502, and, according to an example embodiment, includes receiving market data related to a first plurality of financial instruments, including sortable data for a first aspect and a second aspect associated with the first plurality of financial instruments.

In block 1504, the method 1500 includes outputting, by a processor, for display, a visual representation of the market data, the visual representation comprising a table having a plurality of rows corresponding to the first plurality of financial instruments, and a plurality of columns including a first column corresponding to the first aspect and a second column corresponding to the second aspect.

In block 1506, the method 1500 includes, responsive to receiving an indication to sort by the first aspect, sorting in a first instance, according to the first aspect, the market data related to the subset of the plurality of financial instruments, wherein a relative position, in the table, of rows corresponding to the first plurality of financial instruments is selected to reflect the sorting in the first instance.

In block 1508, the method 1500 includes, responsive to receiving an indication to sort by the second aspect, sorting in a second instance, according to the second aspect, the market data related to the subset of the plurality of financial instruments, wherein a plurality of colors associated with rows in the table corresponding to the first plurality of financial instruments is selected to reflect the sorting in the second instance, wherein the sorting in the first instance and the second instance are concurrently reflected in the table.

FIG. 16 depicts a flow chart of a method 1600, according to an example embodiment. As shown in FIG. 16, the method 1600 starts in block 1602, and, according to an example embodiment, includes receiving, at a client system, from a server system, market data related to a subset of a plurality of financial instruments, including sortable data for a first aspect and a second aspect associated with the plurality of financial instruments, the subset of the plurality of financial instruments selected, at the server system, from the plurality of financial instruments based on a threshold corresponding to a third aspect associated with the plurality of financial instruments.

In block 1604, the method 1600 includes outputting, by a processor, for display at the client system, a visual representation of the market data, the visual representation comprising a table having a plurality of rows corresponding to the subset of the plurality of financial instruments, and a plurality of columns including a first column corresponding to the first aspect and a second column corresponding to the second aspect.

In block 1606, the method 1600 includes, responsive to receiving an indication to sort by the first aspect, sorting in a first instance, according to the first aspect, the market data related to the subset of the plurality of financial instruments, wherein a relative position, in the table, of rows corresponding to the subset of the plurality of financial instruments is selected to reflect the sorting in the first instance.

In block 1608, the method 1600 includes, responsive to receiving an indication to sort by the second aspect, sorting in a second instance, according to the second aspect, the market data related to the subset of the plurality of financial instruments, wherein a plurality of colors associated with rows corresponding to the subset of the plurality of financial instruments is selected to reflect the sorting in the second instance, wherein the plurality of colors is based on a gradient between two colors, a first color from the two colors corresponding to a first value for the second aspect and a second color from the two colors corresponding to a second value for the second aspect, and wherein the sorting in the first instance and the second instance are concurrently reflected in the table.

### Example Systems

Various embodiments of the present invention may be embodied in non-transitory computer readable media for execution by one or more processors. An example embodiment may be used in an application of a computing device, such as a smartphone or tablet, but other computing devices, including non-portable computing devices, may also be used.

FIG. 17 depicts a block diagram of illustrative computer system architecture according to an example embodiment. Certain aspects of the present invention, for example, the datacenter server 305 or client application 205, may be embodied in a computing device. It will be understood that the architecture is provided for example purposes only and does not limit the scope of the various embodiments of the systems and methods for measuring and rewarding activity levels.

The architecture of FIG. 17 includes a central processing unit (CPU), where computer instructions are processed; a display interface that acts as a communication interface and provides functions for rendering video, graphics, images, and texts on the display; a keyboard interface that provides a communication interface to a keyboard; and a pointing device interface that provides a communication interface to a pointing device, e.g., a touchscreen or presence-sensitive screen. Example embodiments of the architecture may include an antenna interface that provides a communication interface to an antenna. Example embodiments may include a connection interface. The connection interface may include one or more of a peripheral connection interface and network communication interface, providing a communication interface to an external device or network. In certain embodiments, a camera interface may be provided that acts as a communication interface and provides functions for capturing digital images from a camera. In certain embodiments, a sound interface may be provided as a communication interface for converting sound into electrical signals using a microphone and for converting electrical signals into sound using a speaker. According to example embodiments, a random access memory (RAM) may be provided, where computer instructions and data may be stored in a volatile memory device for processing by the CPU.

According to an example embodiment, the architecture may include a read-only memory (ROM) where invariant low-level system code or data for basic system functions such as basic input and output (I/O), startup, or reception of keystrokes from a keyboard are stored in a non-volatile memory device. According to an example embodiment, the architecture may include a storage medium or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system, application programs (including, for example, a web browser application, a widget or gadget engine, and or other applications, as necessary) and data files are stored. According to an example embodiment, the architecture may include a power source that provides an appropriate alternating current (AC) or direct current (DC) to power components. According to an example embodiment, the architecture may include a telephony subsystem that allows the device to transmit and receive sound over a telephone network. The constituent devices and the CPU may communicate with each other over a bus.

In accordance with an example embodiment, the CPU may have appropriate structure to be a computer processor. In one arrangement, the computer CPU may include more than one processing unit. The RAM may interface with the computer bus to provide quick RAM storage to the CPU during the execution of computing programs such as the operating system application programs, and device drivers. More specifically, the CPU may load computer-executable process steps from the storage medium or other media into a field of the RAM in order to execute computing programs. Data may be stored in the RAM, where the data may be accessed by the computer CPU during execution. In one example configuration, the device may include at least 128 MB of RAM, and 256 MB of flash memory.

The storage medium itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media may allow the device to access computer-executable process steps, application programs and the like, stored on removable and non-removable memory media, to off-load data from the device or to upload data onto the device. A computer program product, such as one utilizing a communication system may be tangibly embodied in storage medium, which may comprise a machine-readable storage medium.

In an example embodiment of the present invention, the computing device computing system architecture may include any number of hardware and/or software applications that are executed to facilitate any of the operations. In an example embodiment, one or more I/O interfaces may facilitate communication between the device computing system architecture and one or more input/output devices. For example, a universal serial bus port, a serial port, a disk drive, a CD-ROM drive, and/or one or more user interface devices, such as a display, keyboard, keypad, mouse, control panel, touchscreen display, microphone, etc., may facilitate user interaction with the device computing system architecture. The one or more I/O interfaces may be utilized to receive or collect data and/or user instructions from a wide variety of input devices. Received data may be processed by one or more computer processors as desired in various embodiments of the present invention and/or stored in one or more memory devices.

One or more network interfaces may facilitate connection of the device computing system architecture inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, a proximity network, etc., for communication with external devices and/or systems. As desired, embodiments of the present invention may include the device computing system architecture with more or less of the components illustrated in FIG. 17.

Certain embodiments of the present invention are described above with reference to block and flow diagrams of systems and methods and/or computer program products according to example embodiments of the present invention. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some embodiments of the present invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

While certain embodiments of the present invention have been described in connection with what is presently considered to be the most practical and various embodiments, it is to be understood that the present invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present invention, including the best mode, and also to enable any person skilled in the art to practice certain embodiments of the present invention, including making and using any devices or systems and performing any incorporated methods. The patentable scope of certain embodiments of the present invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for sorting financial data, comprising:
receiving market data related to a first plurality of financial instruments, including sortable data for a first aspect and a second aspect associated with the first plurality of financial instruments;
outputting, by a processor, for display, a visual representation of the market data, the visual representation comprising a table having a plurality of rows corresponding to the first plurality of financial instruments, and a plurality of columns including a first column corresponding to the first aspect and a second column corresponding to the second aspect;
responsive to receiving an indication to sort by the first aspect, sorting in a first instance, according to the first aspect, the market data related to the subset of the plurality of financial instruments, wherein a relative position, in the table, of rows corresponding to the first plurality of financial instruments is selected to reflect the sorting in the first instance; and
responsive to receiving an indication to sort by the second aspect, sorting in a second instance, according to the second aspect, the market data related to the subset of the plurality of financial instruments, wherein a plurality of colors associated with rows in the table corresponding to the first plurality of financial instruments is selected to reflect the sorting in the second instance,
wherein the sorting in the first instance and the second instance are concurrently reflected in the table.

2. The method of claim 1, the sortable data for the first aspect and the second aspect both being at least one of numerical, textual, or graphical data.

3. The method of claim 1, the plurality of colors based on three colors, the first color from the three colors corresponding to a first range of values for the second aspect, the second color from the three colors corresponding to values for the second aspect below the first range, and the third color from the three colors corresponding to values for the second aspect above the first range.

4. The method of claim 1, the plurality of colors based on a gradient between two colors, a first color from the two colors corresponding to a first value for the second aspect and a second color from the two colors corresponding to a second value for the second aspect.

5. The method of claim 1, the plurality of colors based on user-selected colors, each color from the user-selected of colors corresponding to a user-selected range of values for the second aspect.

6. The method of claim 1, the first plurality of financial instruments being a subset of a second plurality of financial instruments, the subset of the second plurality of financial instruments selected from the second plurality of financial instruments based on a threshold corresponding to a third aspect associated with the plurality of financial instruments.

7. The method of claim 6, the market data received at a client device, the subset of the second plurality financial instruments selected at a server device.

8. The method of claim 6, the cardinality of the subset of the second plurality of financial instruments based on a predetermined maximum.

9. The method of claim 6, the visual representation of the market data updated responsive to changes in the subset of the second plurality of financial instruments selected based on the threshold corresponding to the third aspect. [live updating to server-based top-list]

10. The method of claim 1, the visual representation of the market data updated responsive to changes in value for an aspect of the market data related to a financial instrument from the subset of the second plurality of financial instruments. [live updating to values]

11. A computer program product comprising a non-transitory computer readable medium that stores instructions that, when executed by a computing device, cause the computing device to perform a method comprising:
receiving market data related to a first plurality of financial instruments, including sortable data for a first aspect and a second aspect associated with the first plurality of financial instruments;
outputting, by a processor, for display, a visual representation of the market data, the visual representation comprising a table having a plurality of rows corresponding to the first plurality of financial instruments, and a plurality of columns including a first column corresponding to the first aspect and a second column corresponding to the second aspect;
responsive to receiving an indication to sort by the first aspect, sorting in a first instance, according to the first aspect, the market data related to the subset of the plurality of financial instruments, wherein a relative position, in the table, of rows corresponding to the first plurality of financial instruments is selected to reflect the sorting in the first instance; and
responsive to receiving an indication to sort by the second aspect, sorting in a second instance, according to the second aspect, the market data related to the subset of the plurality of financial instruments, wherein a plurality of colors associated with rows in the table corresponding to the first plurality of financial instruments is selected to reflect the sorting in the second instance,
wherein the sorting in the first instance and the second instance are concurrently reflected in the table.

12. The method of claim 11, the sortable data for the first aspect and the second aspect both being at least one of numerical, textual, or graphical data.

13. The method of claim 11, the plurality of colors based on three colors, the first color from the three colors corresponding to a first range of values for the second aspect, the second color from the three colors corresponding to values for the second aspect below the first range, and the third color from the three colors corresponding to values for the second aspect above the first range.

14. The method of claim 11, the plurality of colors based on a gradient between two colors, a first color from the two colors corresponding to a first value for the second aspect and a second color from the two colors corresponding to a second value for the second aspect.

15. The method of claim 11, the visual representation of the market data updated responsive to changes in value for an aspect of the market data related to a financial instrument from the subset of the second plurality of financial instruments.

16. The method of claim 11, the first plurality of financial instruments being a subset of a second plurality of financial instruments, the subset of the second plurality of financial instruments selected from the second plurality of financial instruments based on a threshold corresponding to a third aspect associated with the plurality of financial instruments.

17. The method of claim 16, the market data received at a client device, the subset of the second plurality financial instruments selected at a server device.

18. The method of claim 16, the cardinality of the subset of the second plurality of financial instruments based on a predetermined maximum.

19. The method of claim 16, the visual representation of the market data updated responsive to changes in the subset of the second plurality of financial instruments selected based on the threshold corresponding to the third aspect.

20. A method for sorting financial data, comprising:
receiving, at a client system, from a server system, market data related to a subset of a plurality of financial instruments, including sortable data for a first aspect and a second aspect associated with the plurality of financial instruments, the subset of the plurality of financial instruments selected, at the server system, from the plurality of financial instruments based on a threshold corresponding to a third aspect associated with the plurality of financial instruments;
outputting, by a processor, for display at the client system, a visual representation of the market data, the visual representation comprising a table having a plurality of rows corresponding to the subset of the plurality of financial instruments, and a plurality of columns including a first column corresponding to the first aspect and a second column corresponding to the second aspect;
responsive to receiving an indication to sort by the first aspect, sorting in a first instance, according to the first aspect, the market data related to the subset of the plurality of financial instruments, wherein a relative position, in the table, of rows corresponding to the subset of the plurality of financial instruments is selected to reflect the sorting in the first instance; and
responsive to receiving an indication to sort by the second aspect, sorting in a second instance, according to the second aspect, the market data related to the subset of the plurality of financial instruments,
wherein a plurality of colors associated with rows corresponding to the subset of the plurality of financial instruments is selected to reflect the sorting in the second instance,
wherein the plurality of colors is based on a gradient between two colors, a first color from the two colors corresponding to a first value for the second aspect and a second color from the two colors corresponding to a second value for the second aspect, and
wherein the sorting in the first instance and the second instance are concurrently reflected in the table.
